(19) United States
(12) Patent Application Publication
(10) Pub. No.: US 2010/0189119 A1
(43) Pub. Date: Jul. 29, 2010

(54) SWITCH APPARATUS, CARD, AND MANAGEMENT METHOD OF FDB INFORMATION

(76) Inventor: SATOSHI SAWADA, Tokyo (JP)

Correspondence Address: Mr. Jackson Chen, 6535 N. STATE HWY 161, IRVING, TX, 75039, US

(21) Appl. No.: 12/692,846

(22) Filed: Jan. 25, 2010

(30) Foreign Application Priority Data
Jan. 27, 2009 (JP) JP2009-014919

(51) Int. Cl. H04L 12/56

(52) U.S. Cl. 370/401

(57) ABSTRACT

The switch apparatus includes at least one first card having a switch installed therein or more, and a second card, wherein the first card includes an update unit that, in the case of having detected FDB information that is not present in its own switch, transmits it to the second card, and updates the FDB information of its own switch with the FDB information being transmitted from the second card; and wherein the second card includes a manager that collects the FDB information being transmitted from each first card, updates the FDB information of the switch apparatus, and transmits the updated FDB information to each card.

### INCORPORATION BY REFERENCE

This application is based upon and claims the benefit of priority from Japanese patent application No. 2009-014919, filed on Jan. 27, 2009, the disclosure of which is incorporated herein in its entirety by reference

### RELATED ART

The present invention relates to a switch apparatus, a card, and a management method of FDB (Forwarding Data Base) information.

The switch apparatus has performed packet processing so far by using one Layer 2 switch (L2SW) in the apparatus. The large-scale switch apparatus, however, necessitates the apparatus configuration corresponding to various kinds of applications, in which a plurality of cards each having the L2SW installed therein are prepared and mounted. Further, installation of a plurality of the L2SWs are initiated in order to distribute a load because a progress in a high speediness of a circuit is remarkable in recent years, and the application that is impossible to assemble with a configuration having one L2SW has appeared. In such a manner, there is the case that one switch apparatus is configured by use of a plurality of the cards each having the L2SW installed therein, depending upon the apparatus configuration, and in this case, the L2SWs, which learn MAC addresses, exist in plural.

Thereupon, the technology that enables destination information corresponding to a destination address to be effectively learned in each line card is disclosed in Patent document 1 (JP-P2004-193821A).

In the technology of the Patent document 1, a MAC bridge into which frames have been inputted floods the frames when it is found that the destination address is not present in a Mac table. At this point, a CPU inquires of the CPUs of other line cards whether or not they have already learned the above MAC address. The CPU that has detected the corresponding entry in a detected MAC table extracts information in the entry from the MAC table, and responds to the CPU having made an inquiry. The CPU of the line card having made an inquiry registers the above MAC address and its destination in the MAC table based upon the response from the CPU of the line card having made a response.

However, in the technology of the Patent document 1, the CPU of each line card has to make a response individually, and a quick response is impossible.

Further, no countermeasure in the case that a port migration of the packet has occurred is taken in consideration. It is assumed that, for example, in a situation where the MAC address learning has been normally performed in each of a first line card and a second line card, when the packet already inputted into the second line card is one that has come from a third line card, the CPU of the third line card inquires the MAC address, and the first line card makes a response hereto. In such a case, the packet, which has come from the first line card, results in being transmitted to the second line card notwithstanding a migration of the transmission destination of the packet, of which the original destination is the second line card, from the second line card to the third line card. In such a manner, in the case that the port migration striding over the L2SW has occurred in the apparatus having a plurality of the L2SWs installed therein, the technology of the Patent document 1 is not configured so as to take the above migration in consideration.

In addition, when the line card fails, the technology of the Patent document 1 incurs the occurrence of packet flooding and the process of inquiring the MAC address whenever the packet is inserted again, and hence, causes a problem of increasing a processing load of the CPU due to the process of inquiring the MAC address.

In such a manner, there exists a problem that the transmission/reception of the packet is not normally performed, and the packet cancellation, the packet flooding, or the like occurs unless each L2SW has the identical FDB information.

Further, there exists a problem as well that when the FDB information coming from each card is much, it takes much time to exchange and process the above information, which causes the time required for the packet cancellation and the packet flooding to be lengthened.

### SUMMARY OF THE INVENTION

Thereupon, the present invention has been accomplished in consideration of the above-mentioned problems, and an object thereof is to provide a switch apparatus, a card, and a management method of FDB information that enable the FDB information of the apparatus to be effectively learned.

The present invention for solving the above-mentioned problems, which is a switch apparatus including at least one first card having a switch installed therein or more, and a second card, is characterized in that the foregoing first card includes an update unit that, in the case of having detected FDB information that is not present in its own switch, transmits it to the foregoing second card, and updates the FDB information of its own switch with the FDB information being transmitted from the foregoing second card, and the foregoing second card includes a manager that collects the FDB information being transmitted from each first card, updates the FDB information of the switch apparatus, and transmits the updated FDB information to each card.

The present invention for solving the above-mentioned problems, which is a card, is characterized in including a manager that collects FDB information being transmitted from the card having a switch installed therein, updates the FDB information of a switch apparatus, and transmits the updated FDB information to each card.

The present invention for solving the above-mentioned problems, which is a management method of FDB information in a switch apparatus including at least one first card having a switch installed therein or more, and a second card, is characterized in that the foregoing first card, in the case of having detected FDB information that is not present in its own switch, transmits it to the foregoing second card, and updates the FDB information of its own switch with the FDB information being transmitted from the foregoing second card, and the foregoing second card collects the FDB information being transmitted from each first card, updates the FDB information of the switch apparatus, and transmits the updated FDB information to each card.

The present invention makes it possible to effectively learn the FDB information of the switch apparatus.

### BRIEF DESCRIPTION OF THE DRAWINGS

This and other objects, features and advantages of the present invention will become more apparent upon a reading of the following detailed description and drawings, in which:

FIG. 1 is a block diagram of a switch system in this embodiment;

FIG. 2 is a view for explaining an operation of the switch apparatus;

FIG. 3 is a view for explaining an operation of the switch apparatus;

FIG. 4 is an operational flowchart in this embodiment;

FIG. 5 is an operational flowchart in this embodiment;

FIG. 6 is a view illustrating FDB information inside L2SWs 11 of initial cards A and C;

FIG. 7 is a view illustrating a content of a FDB information memory 23 of the card B;

FIG. 8 is a view illustrating a content of a FDB information memory 22 that corresponds to the card A;

FIG. 9 is a view illustrating a content of the FDB information memory 22 that corresponds to the card C;

FIG. 10 is a view illustrating a storage example of a FDB information memory 131;

FIG. 11 is a view illustrating FDB information stored in the FDB information memory 22 that corresponds to the card A;

FIG. 12 is a view illustrating a content of the FDB information of the FDB information memory 23;

FIG. 13 is a view illustrating a content of the FDB information that is written into FDB information memories 132 of the cards A and C; and

FIG. 14 is a view illustrating a content of the FDB information inside the L2SWs 11 of the cards A and C.

### Exemplary Embodiments

The embodiments of the present invention will be explained.

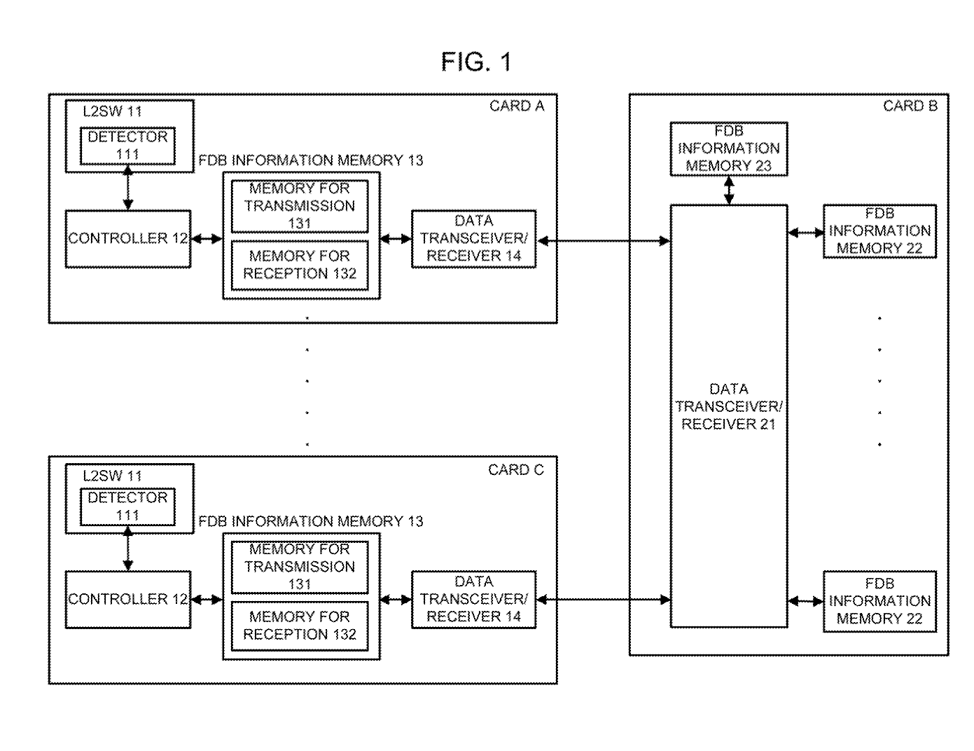

FIG. 1 is a block diagram of the switch system in this embodiment;

As shown in FIG. 1, the switch apparatus of this embodiment includes a card A and a card C each having the L2SW installed therein, and a card B that collects and manages the FDB information of the card A and card C. Additionally, while, in this embodiment, an explanation is made on the assumption that the numbers of the cards having the L2SW installed therein is two, namely the card A and the card C for a purpose of facilitating understanding, the number of cards, which is not limited hereto, may be three or more. Further, each of the card A and card C assumes a similar configuration, so only the card A will be explained.

The card A includes a L2SW 11, a controller 12, a FDB information memory 13, and a data transceiver/receiver 14.

The L2SW 11, which is a switch for performing a switching operation of a Layer 2 level based upon the FDB information, has the FDB information for transferring the received packets stored inside it, and the packets are transferred based upon the FDB information inside the L2SW. Herein, the so-called FDB information is a MAC address, a port number, a VLAN ID, or the like, and the MAC address, the port number, and the VLAN ID are stored corresponding to each other as FDB information. Additionally, the VLAN ID etc. is not always required as FDB information. Further, it is assumed that the ports are allotted to the respective switches so that the ports do not overlap each other. The L2SW 11, as described later, includes the detector 111 that detects that the information corresponding to the received packet is not present in the FDB information inside it, and notifies the above FDB information of the packet to the controller 12.

The FDB information memory 13 includes a FDB information memory 131 (a memory for transmission) in which the FDB information being transmitted from the card A to the card B is stored, and a FDB information memory 132 (a memory for reception) in which the FDB information being transmitted from the card B to all cards is stored. A source MAC address and the VLAN ID of the packet that are not present in its own FDB information, and port information indicative of the port from which the above packet has come are stored in the FDB information memory 131 that is a memory into which the controller 12 writes the FDB information based upon the information coming from the L2SW 11. Further, the FDB information being transmitted from the card B to all cards, which is the source MAC address, being FDB information of the switch apparatus, the VLAN ID, and the port information, is stored in the FDB information memory 132. Additionally, while, in this embodiment, the FDB information memory 13 was divided into the FDB information memory 131 and the FDB information memory 132 for a purpose of facilitating understanding, the FDB information memory 13 is not limited hereto, and as the case may be, one memory region may be divided into two regions and a configuration may be made so that the transmitted information and the received information can be distinguished from each other.

The controller 12 takes a control for collecting the FDB information from the detector 111 of the L2SW 11, and writing new FDB information into the FDB information memory 131. Further, the controller 12 also takes a control for reading out the FDB information coming from the card B from the FDB information memory 132, and writing it into the FDB information inside the L2SW 11.

The data transceiver/receiver 14 is connected to the FDB information memory 13, and a data transceiver/receiver 21 of the card B. The data transceiver/receiver 14 transmits the FDB information of the FDB information memory 131 to the data transceiver/receiver 21 at the time that the controller 12 has written the FDB information into the FDB information memory 131, or at an arbitrary time. Further, the data transceiver/receiver 14 writes the FDB information coming from the data transceiver/receiver 21 of the card B into the FDB information memory 132, and notifies the controller 12 that the FDB information has been written.

The card B includes the data transceiver/receiver 21, a plurality of FDB information memories 22 mounted correspondingly to each card, a FDB information memory 23 for controlling the FDB information of the apparatus.

The data transceiver/receiver 21 is connected to the data transceiver/receiver 14 of each card, the plurality of FDB information memories 22, and the FDB information memory 23.

The data transceiver/receiver 21, which is connected to the data transceiver/receiver 14 of each card by means of individual control signals, writes the FDB information received from the data transceiver/receiver 14 of each card into the FDB information memories 22 allotted card by card.

Further, at the moment that the data transceiver/receiver 21 writes the FDB information of each FDB information memory 22 into the FDB information memory 23, it compares the FDB information to be written with the FDB information stored in the FDB information memory 23, and when the FDB information to be written differs from the FDB information stored in the FDB information memory 23 in a port number, or when the MAC address has not been registered yet, the data transceiver/receiver 21 overwrites a value of the FDB information memory 23 existing in the above location with the above FDB information or newly writes the above FDB information.

The data transceiver/receiver 21, upon finishing the comparison and the writing of the FDB information, transmits the FDB information of the FDB information memory 23 to the data transceivers/receivers 14 of all cards.

The FDB information memories 22 are mounted correspondingly to respective cards (for example, the card A and the card C), and each of the FDB information memories 22 is connected to the data transceiver/receiver 21. The FDB information transmitted from the data transceiver/receiver 14 of the corresponding card is stored in each of the FDB information memories 22.

The FDB information memory 23 is connected to the data transceiver/receiver 21. For the FDB information memory 23, the overwriting is performed with the FDB information stored in each FDB information memory 22, or the above FDB information is newly written, and the FDB information is stored as the switch apparatus (the entirety of the cards).

The switch apparatus configured as mentioned above operates in the main as follows.

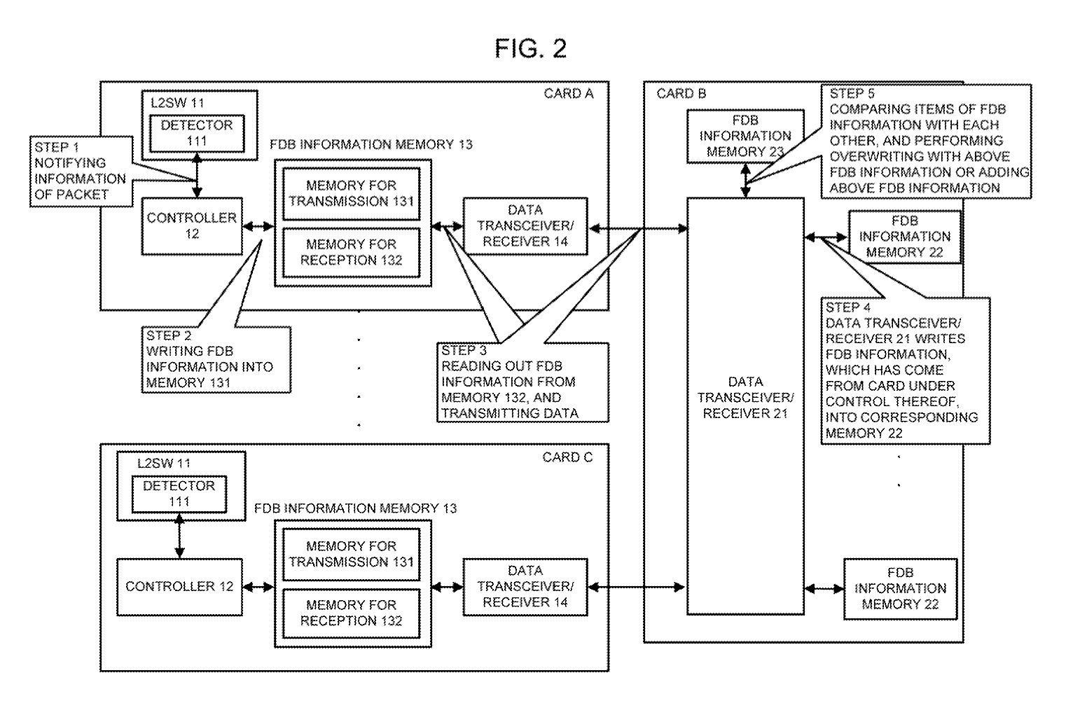

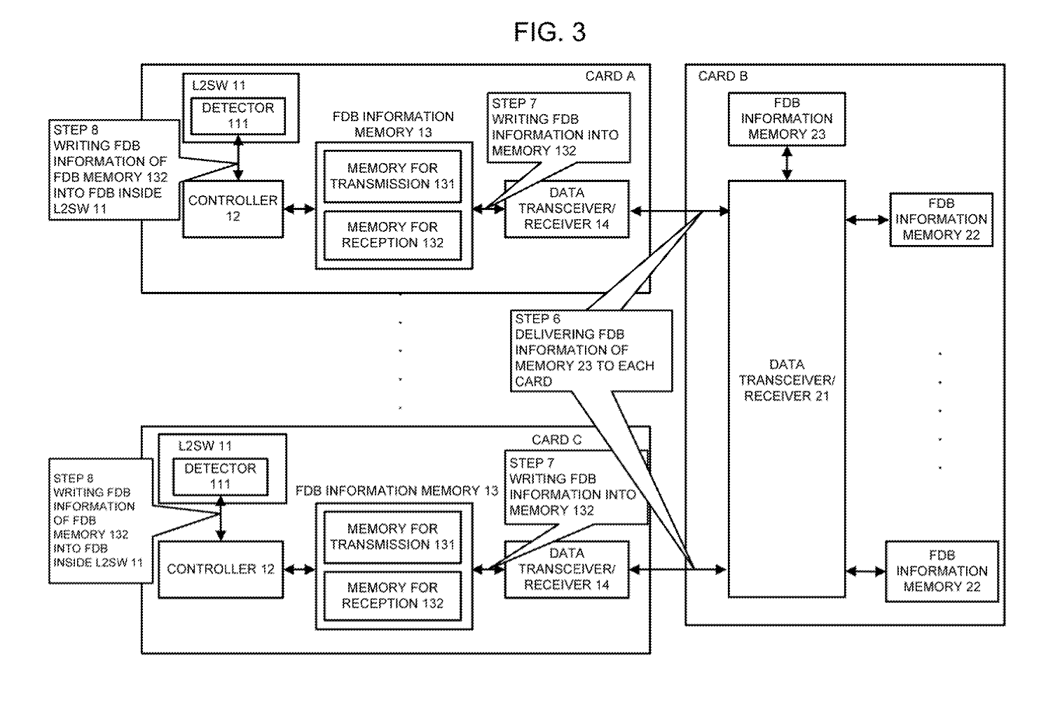

Each of FIG. 2 and FIG. 3 is a view for explaining an operation of the switch apparatus.

Firstly, the L2SW 11 of the card A receives the packet from the port under control thereof, and when the corresponding packet information is not present in the FDB information inside the L2SW 11, the detector 111 of the L2SW 11 notifies various kinds of the information (FDB information) of the packet to the controller 12 (Step 1 of FIG. 2).

The controller 12 writes the source MAC address, the VLAN ID, and the information of the port into the FDB information memory 131, depending upon the information (FDB information) of the packet received from the L2SW 11, and more specifically, it writes these items of information as data into an address generated based upon the source MAC address and the VLAN ID (Step 2 of FIG. 2). Doing so enables the comparison of the FDB information to be made in a small scope, and the process thereof to be performed at a high speed notwithstanding the comparison of the FDB information that the data transceiver/receiver 21 performs at the moment of generating the FDB information.

The data transceiver/receiver 14 reads out the FDB information written by the controller 12 at the time that the FDB information has been written into the FDB information memory 131, or at an arbitrary time, and transmits it to the data transceiver/receiver 21 of the card B (Step 3 of FIG. 2).

The data transceiver/receiver 21 of the card B writes the FDB information transmitted from the data transceiver/receiver 14 into the FDB information memories 22 prepared card by card (Step 4 of FIG. 2).

Continuously, the data transceiver/receiver 21 reads out the FDB information written into the FDB information memory 22, and writes it into the FDB information memory 23. At this time, the data transceiver/receiver 21 compares the FDB information to be written with the FDB information written into the FDB information memory 23, and when the port number differs, or when the MAC address has not been registered yet, the data transceiver/receiver 21 overwrites a value of the FDB information memory 23 existing in the above location with the above FDB information, or newly writes the above FDB information (Step 5 of FIG. 2).

The data transceiver/receiver 21, after writing the FDB information into the FDB information memory 23, multicast-delivers the FDB information of the FDB information memory 23 to the data transceiver/receiver 14 of each card (Step 6 of FIG. 3).

The data transceivers/receivers 14 of the cards A and C write the FDB information transmitted from the data transceiver/receiver 21 into the FDB information memory 132 (Step 7 of FIG. 3).

The controllers 12 of the cards A and C write the FDB information written into the FDB information memory 132 into the FDB information inside the L2SW 11 (Step 8 of FIG. 3).

This enables the L2SW installed in each card to have the identical FDB information as an entirety of the switch apparatus.

In addition, an operation will be explained by employing specific examples.

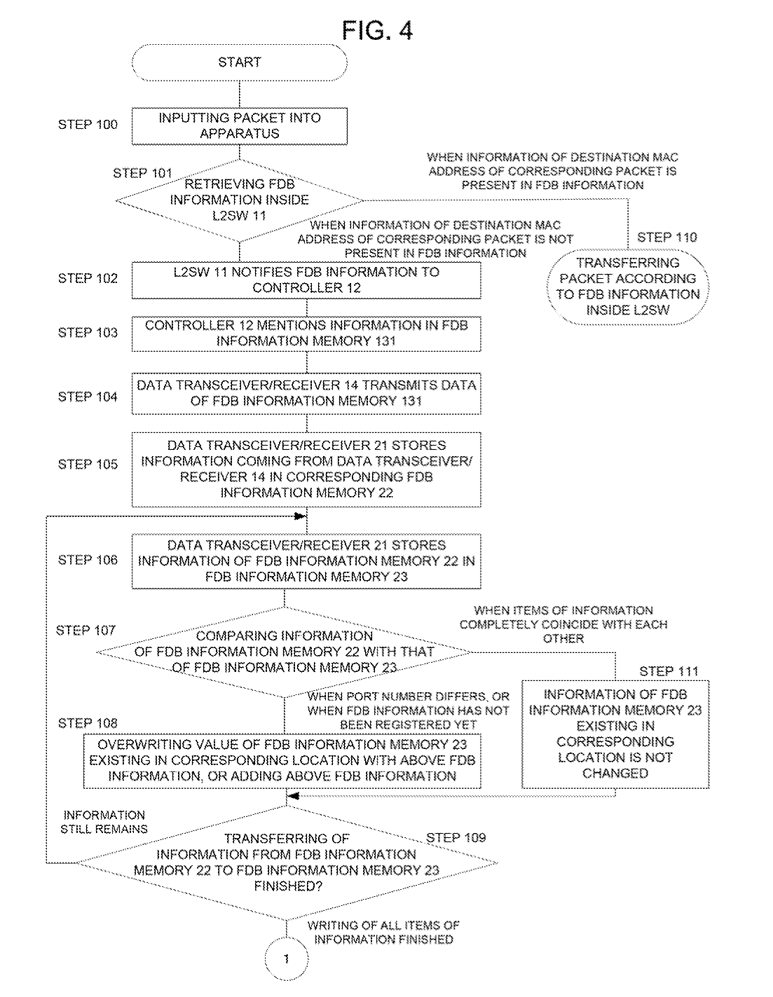

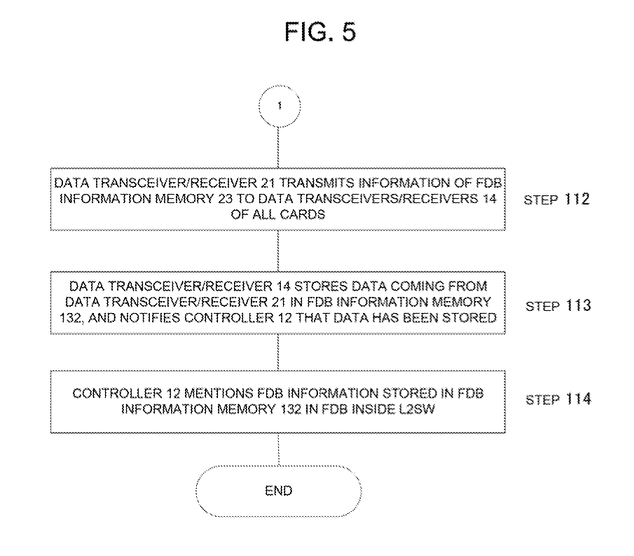

Each of FIG. 4 and FIG. 5 is an operational flowchart in this embodiment.

At first, the packet is inputted into the card having the switch apparatus (Step 100).

The L2SW 11 retrieves the FDB information inside it (Step 101). When the information of the destination MAC; address of the corresponding packet is present in the FDB information inside the L2SW 11, the L2SW 11 performs a packet transfer according to the FDB information inside the L2SW 11 (Step 110). On the other hand, when the information of the destination MAC address of the corresponding packet is not in the FDB information inside the L2SW 11, the detector 111 of the L2SW 11 notifies the FDB information (the MAC address, the port number, and the VLAN ID) of the packet of which the destination MAC address is not present to the controller 12 (Step 102).

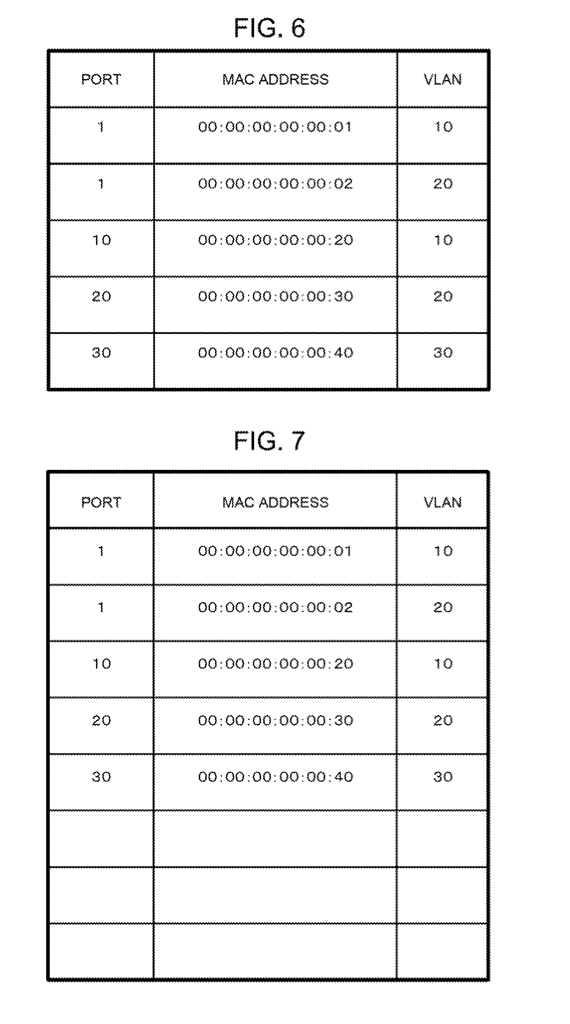

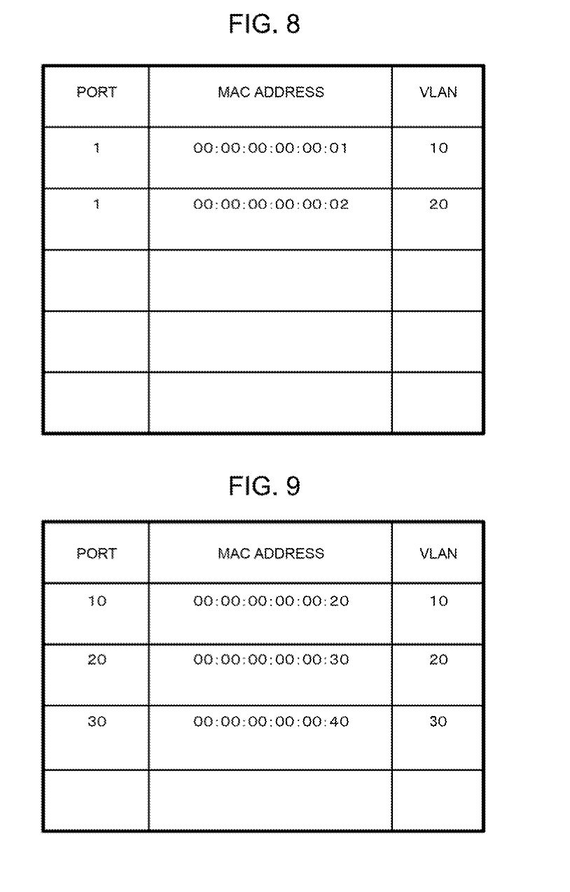

Herein, it is assumed that, as a specific example, the FDB information inside the L2SWs 11 of the initial cards A and C is a content shown in FIG. 6, the FDB information memory 23 of the card B has a content shown in FIG. 7, the FDB information memory 22 corresponding to the card A has a content shown in FIG. 8, and the FDB information memory 22 corresponding to the card C has a content shown in FIG. 9. And, it is assumed that the L2SW 11 of the card A has received the packet, of which the destination MAC address and the VLAN ID are “00:00:00:00:00:10” and “10”, respectively, at a port number “2”. Whereupon, this address is not present in the FDB information inside the L2SW 11 of the card A as shown in FIG. 6, so the detector 111 of the L2SW 11 notifies the port number “2”, the MAC address “00:00:00:00:00:10”, and the VLAN ID “10”, being the FDB information of the received packet, to the controller 12.

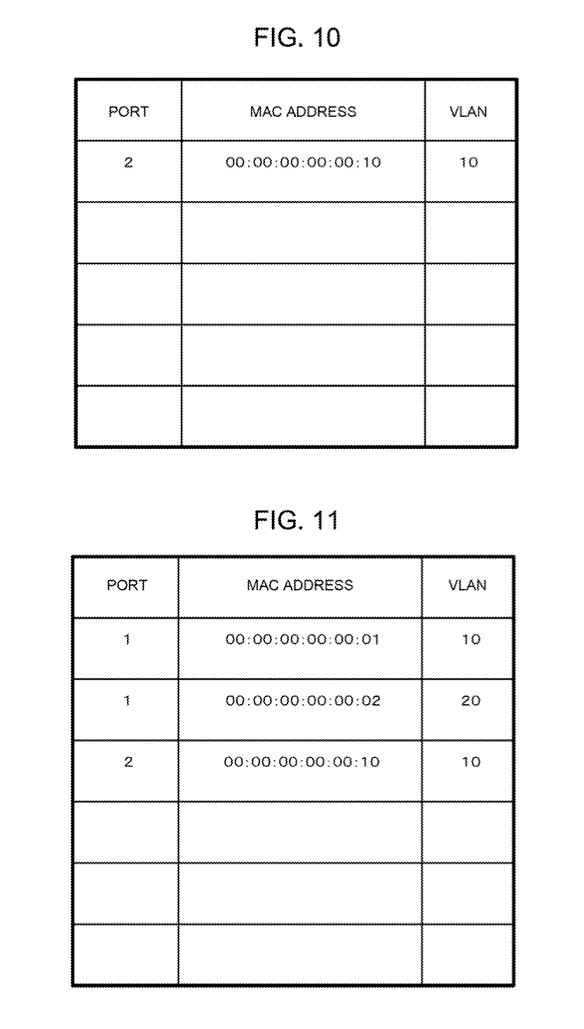

The controller 12 stores the notified FDB information in the FDB information memory 131 (Step 103). In the foregoing example, the notified information is the port number “2”, the MAC address “00:00:00:00:00:10”, and the VLAN ID “10”, so the controller 12 stores the above information in the FDB information memory 131 as shown in FIG. 10.

The data transceiver/receiver 14 transmits the FDB information newly stored in the FDB information memory 131 to the data transceiver/receiver 21 (Step 104). In the foregoing example, the FDB information stored in the FDB information memory 131 is the port number “2”, the MAC address “00:00:00:00:00:10”, and the VLAN ID “10”, so the data transceiver/receiver 14 transmits this FDB information to the data transceiver/receiver 21.

The data transceiver/receiver 21 stores the information coming from the data transceiver/receiver 14 of the card A in the corresponding FDB information memory 22 (step 105). In the foregoing example, the notified data is the port number “2”, the MAC address “00:00:00:00:00:10”, and the VLAN ID “10”, so the data transceiver/receiver 21 stores the notified FDB information in the FDB information memory 22 that corresponds to the card A. FIG. 11 is a view illustrating the FDB information stored in the FDB information memory 22 that corresponds to the card A.

Continuously, the data transceiver/receiver 21 stores the FDB information stored in the FDB information memory 22 corresponding to the card A in the FDB information memory 23 (step 106). In the foregoing example, the FDB information stored in the FDB information memory 22 corresponding to the card A is a port number “1”, a MAC address “00:00:00:00:00:01”, and the VLAN ID “10”; the port number “1”, a MAC address “00:00:00:00:00:02”, and a VLAN ID “20”; and the port number “2”, the MAC address “00:00:00:00:00:10”, and the VLAN ID “10”, so the data transceiver/receiver 21 stores this in the FDB information memory 23.

At this time, the data transceiver/receiver 21 compares a content of the FDB information memory 22, which is to be stored, with a content of the FDB information memory 23 (Step 107). And, when the FDB information of the FD information memory 22, which is to be store, differs from the FDB information of the FDB information memory 23, the data transceiver/receiver 21 overwrites a value of the FDB information memory 23 with the above FDB information, or newly writes the above FDB information (Step 108). Specifically, when the port number differs, or when the MAC address has not been registered yet, the data transceiver/receiver 21 overwrites a value of the FDB information memory 23 existing in the corresponding location with the above FDB information, or newly writes the above FDB information. On the other hand, when the FDB information of the FDB information memory 22, which is to be stored, coincides with the FDB information of the FDB information memory 23, the data transceiver/receiver 21 does not change the information of the FDB information memory 23 existing in the corresponding location (Step 111).

In the foregoing example, a content of the FDB information of the FDB information memory 23 prior to the comparison/writing of the FDB information is the port number “1”, the MAC address “00:00:00:00:00:01”, and the VLAN ID “10”; the port number “1”, the MAC address “00:00:00:00:00:02”, and the VLAN ID “20”; and the port number “10”, a MAC address “00:00:00:00:00:20”, and the VLAN ID “10”; a port number “20”, a MAC address “00:00:00:00:00:30”, and the VLAN ID “20”; and a port number “30”, a MAC address “00:00:00:00:00:40”, and a VLAN ID “30” as shown in FIG. 7.

On the other hand, the FDB information being notified from the data transceiver/receiver 21 is the port number “1”, the MAC address “00:00:00:00:00:01”, and the VLAN ID “10”; the port number “1”, the MAC address “00:00:00:00:00:02”, and the VLAN ID “20”; and the port number “2”, the MAC address “00:00:00:00:00:10”, and the VLAN ID “10”.

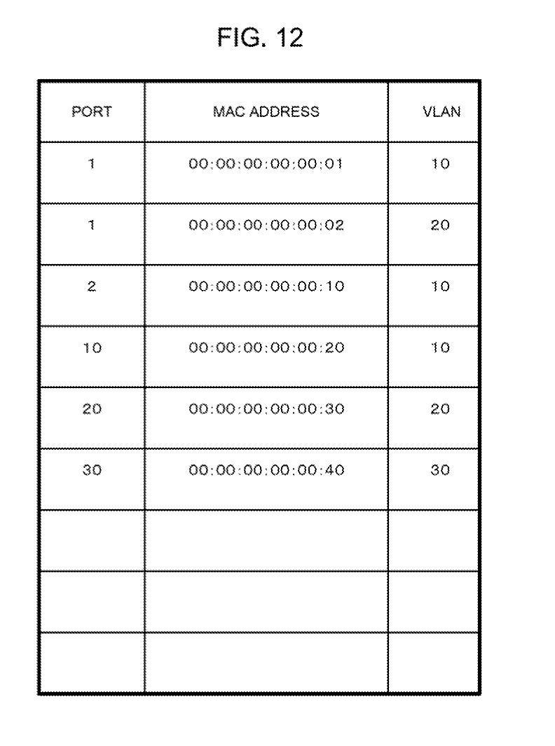

Thus, as a result of the comparison, the FDB information being newly added to the FDB information memory 23 is the port number “2”, the MAC address “00:00:00:00:00:10”, and the VLAN ID “10” as shown in FIG. 12.

A judgment is made as to whether the transfer of the information from all of the FDB information memories 22 to the FDB information memory 23 has been finished (Step 109), and when the transfer has not been finished yet, the operation returns to the Step 106.

When the writing of all data has been finished, the data transceiver/receiver 21 transmits the information of the FDB information memory 23 to the data transceivers/receivers 12 of all cards (step 112). Herein, the information being transmitted, which includes the newly added FDB information, is the port number “1”, the MAC address “00:00:00:00:00:01”, and the VLAN ID “10”; the port number “1”, the MAC address “00:00:00:00:00:02”, and the VLAN ID “20”; the port number “2”, the MAC address “00:00:00:00:00:10”, and the VLAN ID “10”; the port number “10”, the MAC address “00:00:00:00:00:20”, and the VLAN ID “10”; the port number “20”, the MAC address “00:00:00:00:00:30”, and the VLAN ID “20”; and the port number “30”, the MAC address “00:00:00:00:00:40”, and the VLAN ID “30”.

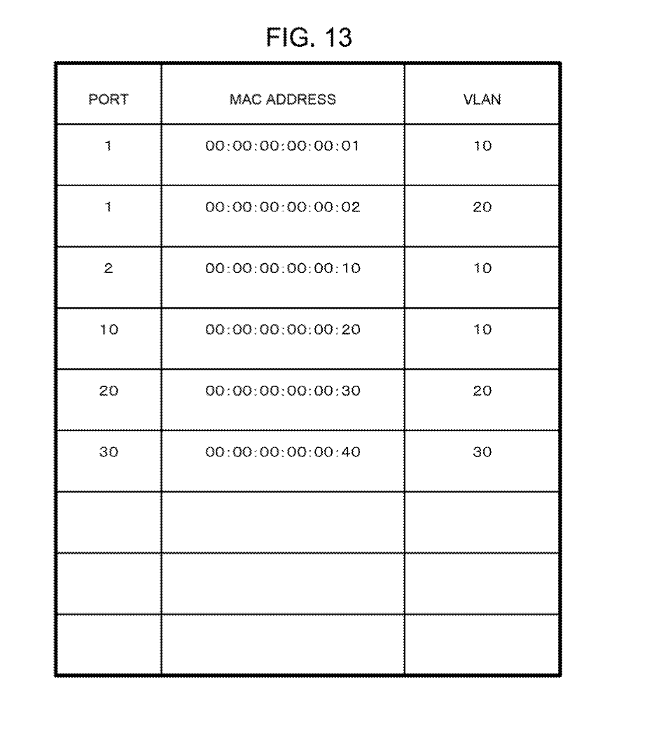

The data transceivers/receivers 14 of the cards A and C write the FDB information received from the data transceivers/receivers 21 into the FDB information memory 132, and notifies the controllers 12 of the cards A and C that the received FDB information has been written into the FDB information memory 132 (step 113). In the foregoing example, the FDB information being written into the FDB information memories 132 of the cards A and C is the port number “1”, the MAC address “00:00:00:00:00:01”, and the VLAN ID “10”; the port number “1”, the MAC address “00:00:00:00:00:02”, and the VLAN ID “20”; the port number “2”, the MAC address “00:00:00:00:00:10”, and the VLAN ID “10”; the port number “10”, the MAC address “00:00:00:00:00:20”, and the VLAN ID “10”; the port number “20”, the MAC address “00:00:00:00:00:30”, and the VLAN ID “20”; and the port number “30”, the MAC address “00:00:00:00:00:40”, and the VLAN ID “30” as shown in FIG. 13.

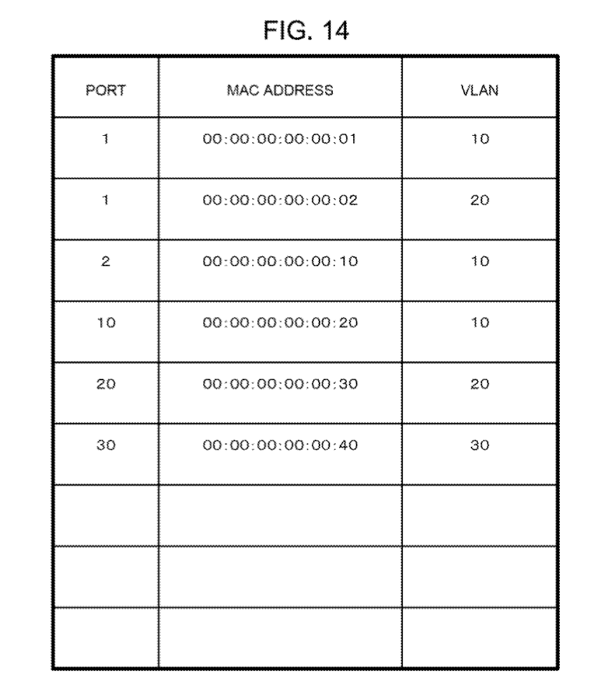

The controllers 12 of the cards A and C overwrite the FDB information inside the L2SW 11 with the FDB information of the FDB information memory 132 (step 114). In the foregoing example, the FDB information inside the L2SWs 11 of the cards A and C is the port number “1”, the MAC address “00:00:00:00:00:01”, and the VLAN ID “10”; the port number “1”, the MAC address “00:00:00:00:00:02”, and the VLAN ID “20”; the port number “2”, the MAC address “00:00:00:00:00:10”, and the VLAN ID “10”; the port number “10”, the MAC address “00:00:00:00:00:20”, and the VLAN ID “10”; the port number “20”, the MAC address “00:00:00:00:00:30”, and the VLAN ID “20”; and the port number “30”, the MAC address “00:00:00:00:00:40”, and the VLAN ID “30” as shown in FIG. 14.

With this, the items of FDB information inside the cards A and C become identical to each other.

Additionally, while the foregoing embodiment presumed that the port numbers of the switches installed in respective cards did not overlap each other, a unique identifier may be affixed to each port number of each switch to employ it instead of the port number so that the port of each switch can be uniquely identified without the port number employed.

Further, each unit in the foregoing embodiment can be also realized with a CPU that operates under a program.

As mentioned above, this embodiment enables a transfer quantity of the information in terms of the FDB information, which is transmitted/received, to be made small because the data being transmitted from the data transceiver/receiver 14 to the data transceiver/receiver 21 is FDB information, being information associated with the modification and the addition. This makes it possible to reduce the time required for generating the FDB information being used inside the L2SW after the packet comes in, and to effectively learn the FDB information of the apparatus.

Further, centralizedly managing the FDB information gives rise to the operation excellent in maintainability and stability, and in addition, enables the switch apparatus as well having the L2SW installed in each card to detect the port migration and to generate its FDB information.

Further, writing the data into the address generated based upon the source MAC address and the VLAN ID at the moment that the card A side or the card C side writes the FDB information into the FDB information memory enables comparison of the FDB information to be made in a small scope, and the process thereof to be performed at a high speed notwithstanding the comparison of the FDB information that the data transceiver/receiver 21 performs at the moment of generating the FDB information.

Further, centralizedly managing the FDB information, which is employed as a switch apparatus, makes it possible to correspond to a redundancy system as well.

Further, the FDB information can be collected quickly because the FDB information sent from the card having the L2SW installed therein is temporarily written into individual memories.

Further, a bottleneck of the control signal does not occurs in the learning of the FDB even though many line cards are installed because the control signals which are used between each of the cards A and C, and the card B for getting items of the information into one shape differ from each other.

Above, while the present invention has been described with respect to the embodiments, the present invention is not always limited to the above-mentioned embodiment, and alterations to, variations of, and equivalents to these embodiments can be implemented without departing from the spirit and scope of the present invention.

The present invention, in which, for example, a plurality of L2SWs are installed in one apparatus, and each of the plurality of L2SWs is mounted in a separate card, can be utilized for the switch apparatus using the common information.

### Further Exemplary Embodiment 1

A switch apparatus, comprising at least one first card having a switch installed therein or more, and a second card:

wherein said first card comprises an update unit that, in the case of having detected FDB information that is not present in its own switch, transmits it to said second card, and updates the FDB information of its own switch with the FDB information being transmitted from said second card; and

wherein said second card comprises a manager that collects the FOB information being transmitted from each first card, updates the FDB information of the switch apparatus, and transmits the updated FDB information to each card.

### Further Exemplary Embodiment 2

A switch apparatus according to Supplement 1:

wherein said update unit of the first card comprises a detector, a controller, a memory, and a transceiver/receiver;

wherein, when the FDB information corresponding to a packet received by the switch is not present in the FDB information of the switch, said detector is configured to notify the above FDB information to said controller;

wherein said controller is configured to write said notified FDB information into a region for transmission of said memory, or updates the FDB information of its own switch with the FDB information written into a region for reception of said memory; and

wherein said transceiver/receiver is configured so that it transmits the FDB information written into the region for transmission of said memory to said second card, or upon receipt of the FDB information from said second card, it writes the received FDB information into the region for reception of said memory.

### Further Exemplary Embodiment 3

A switch apparatus according to Supplement 1 or Supplement 2:

wherein said manager of the second card comprises a transceiver/receiver, a memory mounted correspondingly to said first card, and a management memory; and

wherein said transceiver/receiver is configured so that it writes the FDB information transmitted from said first card into the memory mounted correspondingly to said first card, and compares the FDB information written into the memory mounted correspondingly to said first card with the FDB information stored in said management memory, and when the FDB information written into the memory mounted correspondingly to said first card differs from the FDB information stored in said management memory, it performs overwriting with the above FDB information or newly writes the above FDB information, and transmits the updated FDB information of said management memory to said each first card.

### Further Exemplary Embodiment 4

A switch apparatus according to one of Supplement 1 to Supplement 3, wherein said FDB information includes at least each of a source MAC address and information of a port.

### Further Exemplary Embodiment 5

A card, comprising:

a switch; and

an update unit that, in the case of having detected FDB information that is not present in its own switch, transmits it to the card managing the FDB information, and updates the FDB information of its own switch with the FDB information being transmitted from said card managing the FDB information.

### Further Exemplary Embodiment 6

A card according to Supplement 5:

wherein said update unit comprises a detector, a controller, a memory, and a transceiver/receiver;

wherein, when the FDB information corresponding to a packet received by said switch is not present in the FDB information of the switch, said detector is configured to notify the above FDB information to said controller;

wherein said controller is configured to write said notified FDB information into a region for transmission of said memory, or to update the FDB information of its own switch with the FDB information written into a region for reception of said memory; and

wherein said transceiver/receiver is configured so that it transmits the FDB information written into the region for transmission of said memory to said card managing the FDB information, or upon receipt of the FDB information from said card managing the FDB information, it writes the received FDB information into the region for reception of said memory.

### Further Exemplary Embodiment 7

A card according to Supplement 5 or Supplement 6, wherein said FDB information includes at least each of a source MAC address and information of a port.

### Further Exemplary Embodiment 8

A card, comprising a manager that collects FDB information being transmitted from the card having a switch installed therein, updates the FDB information of a switch apparatus, and transmits the updated FDB information to each card.

### Further Exemplary Embodiment 9

A card according to Supplement 8:

wherein said manager comprises a transceiver/receiver, a memory mounted correspondingly to said each managing card, and a management memory; and

wherein said transceiver/receiver is configured so that it writes the FDB information transmitted from said each card into the memory mounted correspondingly to said each card, and compares the FDB information written into the memory mounted correspondingly to said each card with the FDB information stored in said management memory, and when the FDB information written into the memory mounted correspondingly to said each card differs from the FDB information stored in said management memory, it performs overwriting with the above FDB information or newly writes the above FDB information, and transmits the updated FDB information of said management memory to said each card.

### Further Exemplary Embodiment 10

A card according to Supplement 8 or Supplement 9, wherein said FDB information includes at least each of a source MAC address and information of a port.

### Further Exemplary Embodiment 11

A management method of FDB information in a switch apparatus comprising at least one first card having a switch installed therein or more, and a second card:

wherein said first card, in the case of having detected FDB information that is not present in its own switch, transmits it to said second card, and updates the FDB information of its own switch with the FDB information being transmitted from said second card; and

wherein said second card collects the FDB information being transmitted from each first card, updates the FDB information of the switch apparatus, and transmits the updated FDB information to each card.

### Further Exemplary Embodiment 12

A management method of FDB information according to Supplement 11:

wherein, when the FDB information corresponding to a packet received by the switch is not present in the FDB information of the switch, said first card writes the above FDB information into a region for transmission of a memory, and transmits the FDB information written into the region for transmission of said memory to said second card; and

wherein said first card, upon receipt of the FDB information from said second card, writes the received FDB information into a region for reception of said memory, and updates the FDB information of its own switch with the FDB information written into the region for reception of said memory.

### Further Exemplary Embodiment 13

A management method of FDB information according to Supplement 11 or Supplement 12, wherein said second card writes the FDB information transmitted from said first card into the memory mounted correspondingly to said first card, and compares the FDB information written into the memory mounted correspondingly to said first card with the FDB information stored in a management memory, and when the FDB information written into the memory mounted correspondingly to said first card differs from the FDB information stored in the management memory, said second card performs overwriting with the above FDB information or newly writes the above FDB information, and transmits the updated FDB information of said management memory to said each first card.

### Further Exemplary Embodiment 14

A management method of FDB information according to one of Supplement 11 to Supplement 13, wherein said FDB information includes at least each of a source MAC address and information of a port.

### Further Exemplary Embodiment 15

A program of a card having a switch installed therein, said program causing the card to execute an update process of, in the case of having detected FDB information that is not present in its own switch, transmitting it to the card managing the FDB information, and updating the FDB information of its own switch with the FDB information being transmitted from said card managing the FDB information.

### Further Exemplary Embodiment 16

A program according to Supplement 15, said program causing the card to execute:

a process of, when the FDB information corresponding to a packet received by said switch is not present in the FDB information of the switch, writing the above FDB information into a region for transmission of a memory;

a process of transmitting the FDB information written into the region for transmission of said memory to said card managing the FDB information;

a process of, upon receipt of the FDB information from said card managing the FDB information, writing the received FDB information into the region for reception of said memory; and

a process of updating the FDB information of its own switch with the FDB information written into the region for reception of said memory.

### Further Exemplary Embodiment 17

A program of a card managing FDB information of a card having a switch installed therein, said program causing the card to execute a management process of collecting the FDB information being transmitted from the card having the switch installed therein, updating the FDB information of a switch apparatus, and transmitting the updated FDB information to each card.

### Further Exemplary Embodiment 18

A program according to Supplement 17, said program causing the card to execute:

a process of writing the FDB information transmitted from said each card into a memory mounted correspondingly to said each card;

a process of comparing the FDB information written into the memory mounted correspondingly to said each card with the FDB information stored in a management memory, and when the FDB information written into the memory mounted correspondingly to said each card differs from the FDB information stored in said management memory, performing overwriting with the above FDB information or newly writing the above FDB information; and

a process of transmitting the updated FDB information of said management memory to said each card.

What is claimed is:

1. A switch apparatus, comprising at least one first card having a switch installed therein or more, and a second card:
wherein said first card comprises an update unit that, in the case of having detected FDB information that is not present in its own switch, transmits it to said second card, and updates the FDB information of its own switch with the FDB information being transmitted from said second card; and
wherein said second card comprises a manager that collects the FDB information being transmitted from each first card, updates the FDB information of the switch apparatus, and transmits the updated FDB information to each card.

2. A switch apparatus according to claim 1:
wherein said update unit of the first card comprises a detector, a controller, a memory, and a transceiver/receiver;
wherein, when the FDB information corresponding to a packet received by the switch is not present in the FDB information of the switch, said detector is configured to notify the above FDB information to said controller;
wherein said controller is configured to write said notified FDB information into a region for transmission of said memory, or updates the FDB information of its own switch with the FDB information written into a region for reception of said memory; and
wherein said transceiver/receiver is configured so that it transmits the FDB information written into the region for transmission of said memory to said second card, or upon receipt of the FDB information from said second card, it writes the received FDB information into the region for reception of said memory.

3. A switch apparatus according to claim 1:
wherein said manager of the second card comprises a transceiver/receiver, a memory mounted correspondingly to said first card, and a management memory; and
wherein said transceiver/receiver is configured so that it writes the FDB information transmitted from said first card into the memory mounted correspondingly to said first card, and compares the FDB information written into the memory mounted correspondingly to said first card with the FDB information stored in said management memory, and when the FDB information written into the memory mounted correspondingly to said first card differs from the FDB information stored in said management memory, it performs overwriting with the above FDB information or newly writes the above FDB information, and transmits the updated FDB information of said management memory to said each first card.

4. A switch apparatus according to one of claim 1, wherein said FDB information includes at least each of a source MAC address and information of a port.

5. A card, comprising a manager that collects FDB information being transmitted from the card having a switch installed therein, updates the FDB information of a switch apparatus, and transmits the updated FDB information to each card.

6. A card according to claim 5:
wherein said manager comprises a transceiver/receiver, a memory mounted correspondingly to said each managing card, and a management memory; and
wherein said transceiver/receiver is configured so that it writes the FDB information transmitted from said each card into the memory mounted correspondingly to said each card, and compares the FDB information written into the memory mounted correspondingly to said each card with the FDB information stored in said management memory, and when the FDB information written into the memory mounted correspondingly to said each card differs from the FDB information stored in said management memory, it performs overwriting with the above FDB information or newly writes the above FDB information, and transmits the updated FDB information of said management memory to said each card.

7. A card according to claim 5, wherein said FDB information includes at least each of a source MAC address and information of a port.

8. A management method of FDB information in a switch apparatus comprising at least one first card having a switch installed therein or more, and a second card:
wherein said first card, in the case of having detected FDB information that is not present in its own switch, transmits it to said second card, and updates the FDB information of its own switch with the FDB information being transmitted from said second card; and
wherein said second card collects the FDB information being transmitted from each first card, updates the FDB information of the switch apparatus, and transmits the updated FDB information to each card.

9. A management method of FDB information according to claim 8:
wherein, when the FDB information corresponding to a packet received by the switch is not present in the FDB information of the switch, said first card writes the above FDB information into a region for transmission of a memory, and transmits the FDB information written into the region for transmission of said memory to said second card; and
wherein said first card, upon receipt of the FDB information from said second card, writes the received FDB information into a region for reception of said memory, and updates the FDB information of its own switch with the FDB information written into the region for reception of said memory.

10. A management method of FDB information according to claim 8, wherein said second card writes the FDB information transmitted from said first card into the memory mounted correspondingly to said first card, and compares the FDB information written into the memory mounted correspondingly to said first card with the FDB information stored in a management memory, and when the FDB information written into the memory mounted correspondingly to said first card differs from the FDB information stored in the management memory, said second card performs overwriting with the above FDB information or newly writes the above FDB information, and transmits the updated FDB information of said management memory to said each first card.

11. A management method of FDB information according to one of claim 8, wherein said FDB information includes at least each of a source MAC address and information of a port.
